(19) United States
(12) Patent Application Publication
(10) Pub. No.: US 2013/0053293 A1
(43) Pub. Date: Feb. 28, 2013

(54) BIODEGRADABLE PACKAGE FOR DETERGENT

(71) Applicants: John Dituro, Pine Bush, NY (US); Elise Dauksevicz, Hanson, MA (US); Brian Furze, Tiverton, RI (US); Mark Juckett, Bourne, MA (US)

(72) Inventors: John Dituro, Pine Bush, NY (US); Elise Dauksevicz, Hanson, MA (US); Brian Furze, Tiverton, RI (US); Mark Juckett, Bourne, MA (US)

(21) Appl. No.: 13/520,045

(22) PCT Filed: Dec. 30, 2010
(86) PCT No.: PCT/US10/62579

§ 371 Date: Nov. 13, 2012

Related U.S. Application Data
(60) Provisional application No. 61/291,185, filed on Dec. 30, 2009.

(51) Int. Cl. C11D 17/00; A47L 15/42; D06L 1/00; B65D 90/02

(52) U.S. Cl. 510/277; 220/676; 134/25.2; 510/439; 8/137

(57) ABSTRACT

This invention relates to packaging compositions and methods for improvements in laundering garments and fabrics. The use of such packages with certain detergent containing composition prevents the discharge of pollutants into groundwater, improving the functioning of septic system based wastewater treatment or pretreating wastewater entering sewers leading to water treatment facilities. The compositions include the use of environmentally sustainable ingredients rather than synthetic or petroleum derived compounds.

### CROSS-REFERENCE TO RELATED APPLICATION

This application claims the benefit of the following U.S. Provisional application Ser. No. 61/291,185, filed Dec. 30, 2009, the entire contents of which are incorporated herein by reference.

### BACKGROUND OF THE INVENTION

With the newly found world emphasis on global climate change, the role of water pollution on accelerating change is being reexamined. Western cultural bias in developed countries, with its emphasis on speed and convenience, is slowing shifting to accept alternative methods of cleaning, which are non-polluting and environmentally responsible and sustainable. There is an opportunity, now to introduce into westernized countries a new method of laundering that is based on botanical techniques. However, to be successful in western culture, these botanicals must be modified for use in westernized equipment, such as automated washing machines, and must be convenient to store, use, and handle.

Water pollution continues to be an enormous global problem. Industrial, agricultural and residential effluents continue to pollute our waterways with organic, inorganic and metallic pollutants. Contributing to water pollution is the effect of currently used methods of laundering clothes and fabrics, both in the household and commercially. The most commonly used method in industrialized countries, involves the use of alkaline-based detergents and enzymes in combination with water and agitation in automated washing machines. The discharge of this rinse water, concentrated with detergents and enzymes into sewers leading to wastewater treatment plants, creates an increasing burden on the plant's ability to effectively treat the overwhelming volumes or wastewater. As a result, higher levels of nutrients, such as nitrogen, phosphate and free enzymes, are able to bypass the established wastewater treatment processes and are discharged into waterways. These excess nutrients and enzymes damage fragile ecosystems and are contributing to extinction of native species of flora and fauna and the overgrowth of nuisance and invasive species. The decline of commercial fisheries, contamination of shellfish beds and the rise in frequency of hazardous algal blooms all are the direct result of polluted discharge into waterways. The necessity for proper personal hygiene and health and safety issues associated with disinfection of garments and linens presently exceeds the consequences of its environmental impact.

A common problem with links directly to laundry wastewater discharge is the failure of residential septic systems. When these systems fail, raw untreated wastewater percolates up to the surface and is carried via runoff to surface water lakes and streams during storm events. This contamination of surface waters has become a human health risk as well as an environmental disaster. A major contributing factor in septic system failure is the common practice of discharging laundry wastewater into the septic tank. When this laundry wastewater, with its high pH and concentrated surfactants and enzymes, combines with the nutrient and solids laden wastewater in the tank, the resulting discharge in to the systems leachfield causes the formation of salts and clays, that interfere with the porosity of the soil. Loss of soil porosity, the decrease in interstitial permeability, prevents air exchange that is vital for the leachfield to remain aerobic, which in turn leads to further loss of porosity and eventual catastrophic failure.

With the development of synthetic detergents after World War II, preparations included what are termed builders. The builders' function in a detergent preparation is to bind with polyvalent cations, such a magnesium and calcium ions, in order to enhance a surfactants' ability to remove solids from a substrate. Compounds such as sodium tripolyphospate were commonly added to dry laundry detergent preparations for this purpose. With the banning of high concentration phosphate-based detergents in the 70's, the use pH adjustments to increase surfactant detergency became the norm. The combination of high water temperature, agitation and high pH (above pH 9).

It would be highly desirable if a biodegradable package were developed that is superior to presently available laundry detergent compositions for use in the new generation of automatic washing machines, which require low-sudsing additives in low volumes of wash water. When using the current high-sudsing detergents in these machines the results are unacceptable due to improper rinsing leaving detergent residues on the laundered materials.

### SUMMARY OF THE INVENTION

The present invention relates to novel packaging compositions for laundering and cleaning of clothes, fabrics, upholstery, carpets and other articles of manufacture. The invention describes the use of a combination of natural soap producing botanical fruits in unique dispensing packaging and apparatus. The form and function of this packaging and apparatus, is engineered to be both practical and compostable, there by making this method environmentally sustainable.

In one aspect, the invention provides an environment safeguarding detergent package, where the package contains a Sapindus pericarp or fragment or derivative thereof encased in a biodegradable plastic (e.g., polyester). In one embodiment, the Sapindus is selected from the group consisting of Sapindus delavayi, Sapindus drummondii, Sapindus emarginatus, Sapindus marginatus, Sapindus mukorossi, Sapindus oahuensis, Sapindus rarak, Sapindus saponaria, Sapindus tomentosus, and Sapindus trifoliatus. In another embodiment, the package contains a blend of Sapindus trifoliatus and Sapindus mukorossi. In another embodiment, the polyester is any one or more of polylactic acid, polyhydroxybutyrate, polycaprolactone, polyhydroxyalkanoates, polyhydroxyhexanoate, polybutylene succinate, aliphatic-aromatic copolyesters, polybutylene adipate/terephthalate, polyhyroxyvalerate, polybutylene succinate adipate, polyethylene terephthalate and polymethylene adipate/terephthalate. In one particular embodiment, the package contains a polylactic acid film.

In another aspect, the invention provides an environment safeguarding detergent package, where the package contains a detergent composition containing Sapindus (e.g., a Sapindus pericarp), fragment or derivative thereof, and the detergent composition is encased in a biodegradable plastic or biodegradable bioplastic resin (e.g., a bioplastic resin containing polylactic acid and corn/wheat starch).

In another aspect, the invention provides a laundry kit containing the package of any of the previous aspects and a sachet containing a fragrant botanical (e.g., a plant or plant part derived from a fruit, flower, herb, plant leaf, or plant stem). In one embodiment, the kit contains directions for use of the package and sachet.

In another aspect, the invention provides a method of washing dishes involving the step of providing the package of a previous aspect in an automatic dishwashing machine.

In another aspect, the invention provides a method of washing laundry involving the step of providing the package of any previous aspect in an automatic laundry washing machine.

In various embodiments of the above aspects, the package is perforated. In other embodiments, the perforations are between about 0.5 and 5.0 mm in size. In other embodiments, the perforations number between about 4 and 16 per square inch. In other embodiments, the overall dimensions of the package ranges between about 2″×2.5″ and 5″×8″. In other embodiments, the biodegradable plastic is a film. In other embodiments, the biodegradable plastic is resistant to water and water temperatures between about 80° F. and 160° F. In other embodiments, the package remains intact in a drying device having air influent temperatures of about 347° F. In other embodiments, the package and detergent composition are biodegradable and compostable. In other embodiments, the package and detergent composition biodegrade by about 60% within 180 days in the environment. In other embodiments, the package contains an amount of detergent sufficient for at least about five separate washing periods. In other embodiments, the package contains an indicator of when the package has lost its detergency efficacy. Such indicators are described, for example, in U.S. Patent Publication No. 20080256725, 20090136745, and in U.S. Pat. No. 4,802,255. In still other embodiments, the detergent composition contains or consists of one or more Sapindus pericarps. In still other embodiments, the saponin pericarp is whole, milled, or ground. In still other embodiments, the Sapindus detergent is released into liquid water or steam. In still other embodiments, the package further includes at least one additional botanical that is any one or more of Aloe, prickly pear cactus, chitin, and Moringa oleifera (drumstick tree seed). Preferably, the additional botanicals enhance detergency. In still other embodiments, the additional botanicals modulate the Zeta potential.

It is an object of this invention to provide for methods and compositions for cleaning laundry garments and fabrics and minimizing environmental impact after use by improving wastewater quality of the laundry discharge and also reducing solid waste through the use of sustainable biodegradable packaging.

It is a further object of this invention to provide a method to modify packaging to allow for indicator of when the products detergency has lost it's efficacy after several uses and when it is time to discard the package.

It is still a further object of this invention to include a method or methods to include a fragrance which is imparted to the linens or fabrics that are being washed. This is accomplished either by infusing fragrances or essential oils into the film used to make the outer packaging or by the inclusion of a fragrance sachet, which can be incorporated into the contents along with the saponins, into the final outer package.

It is still a further object of this invention to include a method or methods to include an antimicrobial agents or fabric softening agents in either liquid, powered chemical or dried botanical material forms, which is imparted to the linens or fabrics that are being washed. One method of incorporating these ingredients into the final package, without having them leak from the final package before use, is to include a smaller sachet constructed of a water soluble film, such as polyvinyl acetate, and filed with the desired ingredients. When the final package is placed in the wash water, the incorporated smaller sachet will dissolve releasing the ingredients through the perforations in the outer package.

It is yet still a further object of the present invention is the creation of the fragrance sachet mentioned previously. It also would consist of a package constructed of similar biodegradable film and perforated to allow diffusion of the fragrance into the wash-water. The contents of the sachet can consist of dried botanicals that have a strong and pleasant scent that may impart to the laundered clothing and fabric and/or may contain essential oils that have been loaded onto a non-toxic or biodegradable substrate for the same intended purpose.

It is still a further object of this invention to treat water pollution in the form of discharge water from the laundering process. Modification of the discharge water can act to reverse existing damage to septic system soil porosity, more specifically the soil surrounding and above the leachfield laterals that drain off the wastewater from the septic tank.

It is yet still a further object of the present invention is the manufacture and use of an automatic dispensing device designed specifically for use with the biodegradable saponin package described previously. This device forces water, in hot or cold, or steam form, through the described biodegradable package directly into the wash water. This type of device would be useful in commercial laundering systems and eliminate the need for removal of the biodegradable package from the laundered materials after the cleaning cycle is complete. The device could control the dispensing of the correct amount of active cleaning agents from the disposable package for the particular size and type of laundry load, controlling the volume and duration of water, hot, cold, or in steam form passing over the package and into wash water of the laundry washing device.

The manipulation of plastic films into form and fill packaging is a commonly used practice in production and packaging of many products. This technique folds a flat thin plastic film from a roll, over on itself to and is sealed creating a tube. This tubular structure is quickly filled and sealed on either end, then cut, enclosing the intended contents in a package. Automatic packaging equipment such a the Universal Packaging model 1500 vertical form fill and seal unit⁴ can be used to place the correct amount of botanical (e.g., Sapindus or other saponin-containing plant) and any other additives into the specially developed and perforated biodegradable film. An additional attachment to this packaging unit will allow for the precise dosing of ingredients into each package. This attachment allows for adjustment via weight.

Advantageously, the botanical (e.g., Sapindus, saponin) based package as described by this patent rinses cleanly in low volumes of wash water leaving no residues on the laundered materials.

### BRIEF DESCRIPTION OF THE FIGURES

FIG. 1 illustrates one example of how the packaging film may be arranged, showing the crimping area and the seam area. The text area (a) is the portion available to position instructional text, logos and decorative markings. The perforations (b), allow for the release of detergent components of the filled material in the pouch. A clear window (c) or area of film with no printing is reserved to allow the user to view the contents of the pouch. The dividing line between the individual pouches (d) can be perforated for ease of separation or completely cut to create individual units.

FIG. 2 represents an example of a typical form fill and seal packaging apparatus. Where the roll of packaging material (a.) is fed to the filling cylinder (c.) and tension kept on the material by a spring loaded tensioner/roller (b.). A metal guide or collar forms the material around the cylinder to create a pouch (d.), which is filled with product through the hollow cylinder. The two edges of the packaging material meet and are sealed to form a continuous seam (e.). Below the cylinder, after filling, the pouch is sealed and crimped. The speed of the process controls the “Total Crimp Length (TCL)” (f.) and the pouch “Fill Space length (FS)” (g.). The filled and sealed pouches (h.) are either cut into individual units at the crimp or left as a long string or roll for further packaging.

### DETAILED DESCRIPTION OF THE INVENTION

While the invention is susceptible of embodiment in many different forms, this disclosure will describe in detail preferred embodiments of the invention with the understanding that the present disclosure is to be considered as an exemplification of the principles of the invention and is not intended to limit the broad aspect of the invention to the embodiments illustrated.

### DEFINITIONS

“Bioplastics”, as referred to herein, are plastics that will decompose in the natural environment. Biodegradation of plastics can be achieved by enabling microorganisms in the environment to metabolize the molecular structure of plastic films to produce an inert humus-like material that is less harmful to the environment than traditional plastics. They may be composed of either bioplastics, which are plastics whose components are derived from renewable raw materials. The use of bio-active compounds compounded with swelling agents ensures that, when combined with heat and moisture, they expand the plastic's molecular structure and allow the bio-active compounds to metabolize and neutralize the plastic. More specifically, if desired a starch (i.e., swelling agent) is incorporated into the structure of the plastic polymer matrix during its production. Such swelling agents are starches that are grain-based (e.g., Corn, Wheat, Rice) or tuber-based (e.g., tapioca or potato). During the degradation process, the starch incorporates moisture and enhances microbial growth by providing, for example, a microbial food source. The swelling that occurs leads to disintegration of the polymer structure, further accelerating the degradation process by microbial action of bacteria and fungi. Bioactive compounds include, for example, charged compounds that are able to attract bacterial surface proteins.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

As used herein, “obtaining” as in “obtaining an agent” includes synthesizing, purchasing, or otherwise acquiring the agent.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

“Saponins”, as referred to herein, are glycosides widely distributed in plants. Each saponin consists of one or more sugar moeities bonded to a ‘sapogenin’ aglycon. The sugar moities may be glucose, galactose, or a pentose or methylpentose, while the sapogenin may be a triterpene or a steroid. Saponins have detergent properties, forming oil-in-water emulsions and producing copious quantities of foam or suds when dissolved in water. The name ‘saponin’ is derived from the Latin ‘sapo’ for ‘soap’. Saponin-containing plants have been employed for centuries as soaps, notably soapwort (Saponaria officialis), soaproot (Chlorogalum pomeridianum), soapbark (Quillaja saponaria), and soapberry (Sapindus mukurossi).

Saponins are employed as foaming agents in soft drinks, frozen carbonated beverages, cocktail mixes, and fire extinguishers. Their detergent properties have resulted in their use in shampoos, facial cleansers, and various cosmetic compositions. Anti-microbial and anti-fungal properties as well as nutraceutical and pharmacological benefits have also been attributed to saponins. The traditional methods of extracting and isolating saponins from dry vegetable materials consist of extracting with various alcohols (methanol, ethanol, propanol) or water-alcohol mixtures. A defatting step using non-polar organic solvents (i.e. petroleum ether or hexane) may be performed either prior to the extraction step or on the extract itself. Crude saponins are then precipitated by introducing a large volume of acetone or ether. K. Hostettmann and A. Marston, Saponins, Cambridge University Press (1995), pp. 143-145, which is incorporated herein by reference in its entirety.

The laborious methods used to purify proteins, such as dialysis, ion-exchange chromatography, and size-exclusion chromatography, are often employed to effect further purification of saponins. P. A. Ireland, S. Z. Dziedzic, and M. W. Kearsley, “Saponin Content of Soya and Some Commercial Soya Products by Means of High-performance Liquid Chromatography of the Sapogenins,” J. Sci. Food Agric. 1986, 37, 694-698, which is incorporated herein by reference in its entirety.

“Environment safeguarding detergent” as referred to herein, is a saponin without marked adverse influence on the environment, and is a relatively environment-friendly active agent, with its discharge being minimized. The essential component isolated therefrom or synthesized, volatilize after use, and do not adversely affect rivers. Even after discharge as drain, their active ingredient can wash the drainage pipe. In addition, the detergent composition of the present invention are naturally occurring substances, so that they are harmless to living creatures, and friendly to the environment. As seen from these facts, the detergent of the present invention is a product worth the name of an environment purifying agent.

Unless specifically stated or obvious from context, as used herein, the term “or” is understood to be inclusive. Unless specifically stated or obvious from context, as used herein, the terms “a”, “an”, and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

By “Zeta potential” is meant the electrokinetic potential in a colloidal system.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

### Biodegradable Package Compositions

Biodegradable packages of the present invention are comprised of bioplastics. Bioplastics are a new generation of biodegradable and compostable plastics. They are derived from renewable raw materials, such as starch (e.g. corn, potato, tapioca), cellulose, soy protein, and lactic acid. Preferably, such materials are not produced using hazardous methods, and decompose back into carbon dioxide, water, biomass etc. when discarded. Corn starch is currently the main raw material being used in the manufacture of bioplastic resins. Mater-Bi (main component corn-starch), and PolyActide (PLA) (made from corn-starch as well) are currently the 2 main resins (raw materials), being used today in the production of compostable and biodegradable plastics and are certified for compostability under standards set by international organizations. However, other resins are coming into the market made from potato starch, soybean protein, cellulose etc. Most of these are currently not certified for compostability, though some are certified for biodegradability.

### Heat Resistance

In general, corn-starch based products (bags, cutlery, cold cups, drinking straws) are heat resistant up to about 120 degrees F. and Corn Starch Biodegradable Cutlery is heat resistant up to about 220 degrees F.

### Biodegradability & Compostability

Bioplastics can take different length of times to totally compost, based on the material and are meant to be composted in a commercial composting facility, where higher composting temperatures can be reached. Preferably, bioplastics used in the invention breakdown in between about 90-180 days: This breakdown need not be complete. In one embodiment, a bioplastic package of the invention breaks down by at least about 50%, 60%, 75%, 85%, 90% or even 100% with about 60, 90, 100, 125, 150, 175, or 180 days. In another embodiment, a product of the invention is substantially (e.g., greater than 50%, 60%, 75% or more) composted within about 200 days. Most existing international standards require biodegradation of 60% within 180 days along with certain other criteria for the resin or product to be called compostable. It is important to make the distinction between degradable, biodegradable and compostable. These terms are often (incorrectly) used interchangeably.

Compostable plastic is plastic which is “capable of undergoing biological decomposition in a compost site as part of an available program, such that the plastic is not visually distinguishable and breaks down to carbon dioxide, water, inorganic compounds, and biomass, at a rate consistent with known compostable materials (e.g. cellulose). and leaves no toxic residue.” American Society for Testing & Materials (ASTM). In order for a plastic to be called compostable, three criteria need to be met:
1. Biodegrade—break down into carbon dioxide, water, biomass at the same rate as cellulose (paper).
2. Disintegrate—the material is indistinguishable in the compost, that it is not visible and needs to be screened out
3. Eco-toxicity—the biodegradation does not produce any toxic material and the compost can support plant growth.

Biodegradable Plastic is plastic which will degrade from the action of naturally occurring microorganism, such as bacteria, fungi etc. over a period of time. Note, that there is no requirement for leaving “no toxic residue”, and there is no requirement as tp the time within which the plastic is biodegraded. In one embodiment, a package of the invention is produced using biodegradable plastic.

Degradable Plastic is plastic that will undergo a significant change in its chemical structure under specific environmental conditions resulting in a loss of some properties. There is no requirement that the plastic has to be degraded by the action of “naturally occurring microorganism” or any of the other criteria required for compostable plastics. In another embodiment, a package of the invention is produced using degradable plastic.

A plastic therefore may be degradable but not biodegradable or it may be biodegradable but not compostable (that is, it breaks down too slowly to be called compostable or leaves toxic residue).

The rate of biodegradation for different biocompostables is dependent upon the composition and thickness of the materials, as well as on composting conditions. Commercial composting facilities typically grind the materials they receive, turn over the compost piles, and have compost piles that reach high temperatures. This reduces the amount of time it takes to compost and, is thus, the recommended method for composting these products. Home composting rates are slower and can vary, depending on how frequently the pile is turned over, the moisture and material content and the temperature.

Bioplastics are typically comprised of biodegradable polyesters. Some of the more notable polyesters for biodegradation are polylactic acid, polyhydroxybutyrate, polycaprolactone, polyhydroxyalkanoates, polyhydroxyhexanoate, polybutylene succinate, aliphatic-aromatic copolyesters, polybutylene adipate/terephthalate, polyhyroxyvalerate, polybutylene succinate adipate, polyethylene terephthalate and polymethylene adipate/terephthalate. In certain embodiments, biodegradable polyesters are used to produce a bioplastic package of the invention.

In another embodiment of the present invention, the biodegradable package is comprised of polylactic acid. Polylactic acid or Polylactide (PLA) is a biodegradable, thermoplastic polymer derived from renewable resources.

Polylactic acid can be processed like most thermoplastics into fibers and films. It comes in two common forms: poly-L-lactide (PLLA), which is more crystalline, and poly-DL-lactide (PDLLA), which is more amorphous. PLLA is also commonly blended with poly-D-lactide (PDLA) to improve its physical characteristics: PDLA and PLLA form a highly regular stereocomplex with increased crystallinity, and increased melting point. The maximum effect in temperature stability is achieved with a 50-50 blend, but even lower concentrations of 3-10% of PDLA have a substantial effect. In such cases, PDLA is used as a nucleating agent, thereby increasing the crystallization rate. Due to the higher crystallinity of this stereo-complex, the biodegradability will become slower. However, it is interesting to note that this polymer blend remains transparent. Packages of the invention may comprise about 25-75, 30-70, 40-60, 50-50, 60-40, 70-30, or 75-25 blends of PDLA and PLLA. PDLA allows for flexibility, while PLLA provides strength. One of skill in the art can optimize the blend to achieve the desired attributes for the film.

PLA is particularly attractive as a sustainable alternative to petrochemical-derived products, since the lactate from which it is ultimately produced can be derived from the fermentation of agricultural by-products such as corn starch or other starch-rich substances like maize, sugar or wheat. Moreover, packaging made from PLA is bio-degradable and reverts in less than about 60 days in ideal conditions, namely in commercial composting installations. PLA is commercially available (e.g., from Earth First).

However, PLA is still more expensive than many petroleum-derived commodity plastics, but its price has been falling as more production comes online. The degree to which the price will fall, and the degree to which PLA will be able to compete with non-sustainable petroleum-derived polymers, is uncertain.

Chemical Composition:

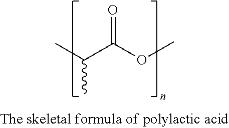

Bacterial fermentation is used to produce lactic acid from corn starch or sugarcane feedstocks, which is oligomerized and then catalytically dimerized to make the monomer for ring-opening polymerization. It can be easily produced in a high molecular weight form through ring-opening polymerization using most commonly a stannous octoate catalyst, but for laboratory demonstrations tin(II) chloride is often employed.

Due to the chiral nature of lactic acid, several distinct forms of polylactide exist: poly-L-lactide (PLLA) is the product resulting from polymerization of L,L-lactide (also known as L-lactide), while the polymerization of a racemic mixture L- and D-lactides leads to the synthesis of poly-DL-lacticle (PDLLA). Any of these forms is useful in the compositions of the invention.

### Physical Properties:

1. PLLA has a crystallinity of around 37%
2. PLLA has a glass transition temperature of 50-80° C.
3. PLLA has a melting temperature of 173-178° C., but can be increased up to 213-228° C. when blended with PDLA.

Applications:

PLA is currently used in a number of biomedical applications, such as sutures, stents, dialysis media and drug delivery devices, but it is also evaluated as a material for tissue engineering. Being biodegradable it can also be employed in the preparation of bioplastic, useful for producing loose-fill packaging, compost bags, food packaging and disposable tableware. In the form of fibers and non-woven textiles PLA also has many potential uses, for example as upholstery, disposable garments, awnings, feminine hygiene products and nappies.

In still another embodiment, the biodegradable package is comprised of polycaprolactone. Polycaprolactone (PCL) is a biodegradable polymer derived from the chemical synthesis of crude oil.

Because of its degradation properties, the primary uses of PCL have been in biomedical applications and as an additive to bioplastics made from other polymers. For example, it can be added to starch to lower its cost and increase biodegradability or it can be added as a polymeric plasticizer to PVC to increase its impact resistance.

Chemical Composition:

PCL can be prepared by ring opening polymerization of ε-caprolactone using a catalyst such as stannous octanoate.

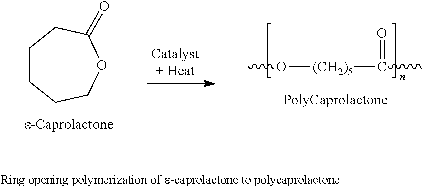

Physical Properties:

1. PCL has good water, oil, solvent and chlorine resistance

2. PCL degrades extremely quickly in open air

3. PCL has a melting temperature of around 60° C.

4. PCL has a glass transition temperature of around −60° C.

Applications:

PCL is degraded by hydrolysis of its ester linkages in physiological conditions (such as in the human body) and has therefore received a great deal of attention for use as an implantable biomaterial. In particular it is especially interesting for the preparation of long term implantable devices, owing to its degradation which is even slower than that of polylactide.

PCL is an Food and Drug Administration (FDA) approved material that is used in the human body as (for example) a drug delivery device, suture (sold under the brand name Monocryl or generically), adhesion barrier and is being investigated as a scaffold for tissue repair via tissue engineering.

In still another embodiment, the biodegradable package is comprised of polyhyroxybutyrate. Polyhydroxybutyrate (PHB) is a biodegradable, thermoplastic polymer derived from renewable resources.

Polyhydroxybutyrate has attracted much commercial interest as a plastic material because its physical properties are remarkably similar to those of polypropylene, even though the two polymers have quite different chemical structures. While PHB appears stiff and brittle, it also exhibits a high degree of crystallinity, a high melting point of about 180° C., but, most importantly, PHB is rapidly biodegradable, unlike polypropylene.

Two major factors inhibiting widespread use of PHB lie in its production costs, which are a lot higher than plastics produced from petrochemicals, and its brittleness, since PHB as it is currently produced cannot handle high impact. There are also some concerns of how large quantities of PHB would affect the environment. In the future research using genetic technology may be able to produce a better bacteria-based plastic that has more desirable properties and is cheaper to produce. For example PHB production may become cheaper if researchers could find a way to make bacteria produce larger amounts of polymer within shorter time spans. If PHB becomes as cheap as plastics produced from petrochemicals, then it will probably become widely used, since it has the potential to be employed for packaging products like bottles, bags, wrapping film and diapers. PHB is being evaluated as a material for tissue engineering scaffolds and for controlled drug-release carriers owing to its biodegradability, optical activity and isotacticity.

Chemical Composition:

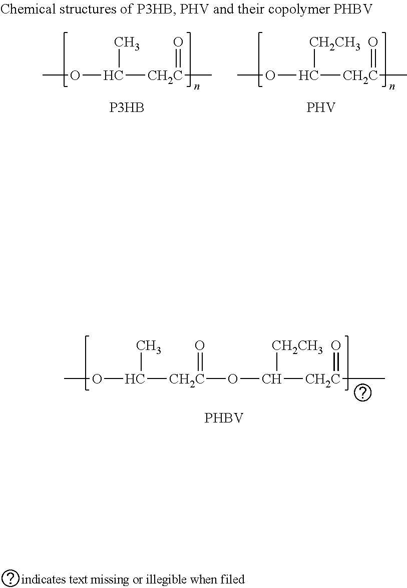

PHB is produced by micro-organisms, apparently in response to conditions of physiological stress. The polymer is primarily a product of carbon assimilation (from glucose or starch) and is employed by micro-organisms as a form of energy storage molecule to be metabolized when other common energy sources are not available.

The poly-3-hydroxybutyrate (P3HB) form of PHB is probably the most common type of polyhydroxyalkanoate, but many other polymers of this class are produced by a variety of organisms: these include poly-4-hydroxybutyrate (P4HB), polyhydroxyvalerate (PHV), polyhydroxyhexanoate (PHH), polyhydroxyoctanoate (PHO) and their copolymers. One or more of these PHBs may be used in compositions of the invention.

Physical Properties:
1. PHB is water insoluble and relatively resistant to hydrolytic degradation. This differentiates PHB from most other currently available biodegradable plastics, which are either water soluble or moisture sensitive.
2. PHB shows good oxygen permeability.
3. PHB has good ultra-violet resistance but has poor resistance to acids and bases.
4. PHB is soluble in chloroform and other chlorinated hydrocarbons.
5. PHB is biocompatible and hence is suitable for medical applications.
6. PHB has melting point 175 C, and glass transition temperature 15 C.
7. PHB has tensile strength 40 MPa which is close to that of polypropylene.
8. PHB sinks in water while polypropylene floats. But sinking of PHB facilitates its anaerobic biodegradation in sediments.
9. PHB is nontoxic.

In all executions under the present invention the packaging may be formed using different techniques known to one of skill in the field of forming packaging. Non-limiting examples of such techniques include molding the raw material of the packaging, especially injection molding or blow molding, and also techniques making use of a preformed film of material, such as thermoforming, vertical form-fill-sealing or horizontal form-fill-sealing.

In the case of techniques making use of preformed film materials, the film may be a single film, or a laminated film. While a single film may have perforations, the two or more layers in a laminate coincide.

The film itself may be produced by any process, for example by extrusion and blowing or by casting. The film may be unoriented, mono-axially oriented or bi-axially oriented. If the layers in the film are oriented, they usually have the same orientation, although their planes of orientation may be different, if desired.

The layers in a laminate may be the same or different. Thus, they may each comprise the same polymer or a different polymer. Examples of polyesters which may be used in a single layer film or in one or more layers of a laminate or which may be used for injection molding or blow molding are described herein.

The thickness of the film used to produce a botanical container, which may be in the form of a pocket, is, in one embodiment between about 31.5 to 300 μm (0.80 to 7.62 mil), in another embodiment between about 80 to 200 μm (2.032 to 5.08 mil), in another embodiment between about 100 to 160 μm (2.54 to 4.064 mil), more specifically between about 62.99 to 150 μm (1.60 to 3.81 mil) and still more specifically between about 78.74 to 150 μm (2.00 to 3.81 mil). (units conversion example: 1 μm=0.0254 mm. and 3 mil (mm) then this is 3 divided by 0.0254=118.11 μm)

In one possible execution using film material, the packaging may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate pocket. The amount of vacuum or pressure and the thermoforming temperature used depend on the thickness and porosity of the film and on the polymer or mixture of polymers being used.

While desirably conditions are chosen within the above ranges, it is possible to use one or more of these parameters outside the above ranges, although it may be necessary to compensate by changing the values of the other two parameters.

In certain embodiments, a container of the invention comprises one or more (e.g., 2, 3, 4) compartments. When the container comprises more than one compartment, each compartment may be formed by any of the above mentioned techniques.

The compartments are then filled with the desired compositions. The compartments may be completely filled or only partially filled with a saponin composition or other botanical. The solid may be, for example, a particulate or granulated solid, or a tablet. The liquid may be non-aqueous or aqueous, for example comprising less than or more than about 5% total or free water. The composition may have more than one phase. For example, it may comprise an aqueous liquid and a liquid which is immiscible with the aqueous liquid.

The container may contain more than one component; for instance it may contain two components which are incompatible with each other. It may also contain a component, which is incompatible with the part of the container enclosing the other component. For example, the second composition may be incompatible with the part of the container enclosing the first composition.

If it is desired that the container releases the components, it is possible to ensure that the components are released at different times. Thus, for instance, one composition can be released immediately the container is added to water, whereas the other may be released later. This may be achieved by having a compartment, which takes longer to dissolve surrounding one of the compositions, which may be either the first or the second composition. This may be achieved, for example, by having different compartment wall thicknesses. Alternatively, the second composition may simply be held on the outside of the sealing member, in which case it can start to dissolve as soon as the article is added to water. In the case of use of a multicompartment packaging different release times may also be achieved by choosing compartments, which dissolve at different temperatures, for example the different temperatures encountered during the cycle of a laundry or dish washing machine.

Alternatively the packaging may be formed of, for example, a moulded composition, especially one produced by injection moulding or blow moulding. The walls of the compartment may, for example, have a thickness of greater than 100 um, for example greater than 150 um or greater than 200 um, 300 um, 500 um, 750 .mu.m or 1 min. Preferably the walls have a thickness of from 200 to 400 um.

### Environment Safeguarding Detergent

Pericarps of the seeds of various members of the Sapindus family have been used in producing soaps and detergents for centuries in Indian and Asian cultures, as well as in central and South America. In the Unites States, Native American Tribes in Florida also used members of the Sapindus family for such purposes. Typically, the pericarps were boiled in hot water and the extract was used as a detergent or the pericarps were placed in a reusable cloth bag with a drawstring closure. When placed in the wash water for laundering purposes, the active compounds from the pericarps would diffuse through the fibers of the cloth bag and have their affect on the laundered materials. Previously used methods have a number of disadvantages that are addressed by the present invention.

First, if the bag is reused, the user must remove spent nuts from the bag and must replace them. This is inconvenient. The bag containing the pericarps must remain structurally intact even after repeated washings. There is a problem with the cloth bags opening and releasing the pericarps into the laundry. This creates a difficult mess to clean up, which involves inspecting each item of laundry and picking out the pericarp pieces by hand. This process is very time consuming and tedious, and would preclude the consumer from using the pericarps again.

Second, the reuse of a cloth based bag opens the possibility of transferring contamination from one load of laundry to the next. This is an issue when dealing with healthcare related laundries in which the necessity to prevent infectious disease is a priority. The biodegradable plastic containers of the invention are less likely to transfer contaminants from one load to the next.

Third, when a cloth bag is used, the bag may retain dyes and soils from previously washed loads and transfer them to the next load of laundry. This is a major concern when dealing with non-steadfast dyes and laundry loads that may acquire stains from the previously used cloth bag.

Fourth, in western culture, consumer product design is focused on convenience rather then sustainability and waste minimization. Little concern is given to the fate and after effects of the discarded packaging. Enclosing the dried fruits in package, that can be discarded after use, is more appealing to the average western consumer than reusable cloth bags.

Fifth, there may be health concerns in the transferring of infectious agents from one load to the next trapped in the fibers of the cloth bag. This would be a concern when laundering hospital linens and uniforms.

In addition to their tremendous detergency over a wide range of temperatures and pH levels, the unique chemical properties of the natural triterpenoidal type saponins concentrated in the pericarp of the Sapindus seed, including oleanolic acid and hedagenin, are capable of reversing damage to leachfield soil porosity by sodium salts. Environmental conditions created by excess sodium chloride in laundry wastewater results in a reduced hydraulic conductivity (Ksat) by disbursing soil clay minerals, as described in Patterson³.

The common method of use for Sapindus seeds involves submerging a cloth bag containing several seed pericarps (3-5) in the laundry wash water. The active components of the seed pericarp diffuse through the weave of the cloth bag and act to remove the soil stains on the clothing or fabrics being laundered. After several washings, the user is required to remove the spent seeds from the bag and replace them with need seeds.

The need for an effective method of cleaning clothes and fabrics that is also environmentally sustainable is evident. To be useful his new method must be simple to implement and fit within the current infrastructure in terms of machines used and discharges produced.

The botanical ingredients include singly or in combination the deseeded and dried pericarp shells of the seeds of various members of the Sapindaceae family in the genera Sapindus including but not limited to the species Sapindus delavayi, Sapindus drummondii, Sapindus emarginatus, Sapindus marginatus, Sapindus mukorossi, Sapindus oahuensis, Sapindus rarak, Sapindus saponaria, Sapindus tomentosus, Sapindus trifoliatus. In one embodiment, the Sapindus mukorossi and Sapindus trifoliatus are blended to provide maximum detergency, while maintaining a reasonable cost. In one embodiment, the two species are blended 50:50, 25:75, or 30:70. In another embodiment, 70-95% of Sapindus mukorossi to 30%-5% of Sapindus trifoliatus is used. The exact percentages used are varied to optimize the detergency of the composition. These pericarps can be included in their whole intact form or may be milled or ground into powered form so as to allowed faster dispersion of the active agents into solution. The particle size must be large enough to prevent their penetration through the perforations of the described biodegradable film package. In general, the smaller the particle size, the better the extraction.

The invention further provides for a separately produced smaller sachet containing fragrant botanicals, of dehydrated flowers, leaves stems or roots, enclosed in a biodegradable plastic film container having perforations. This sachet is intended to impart a pleasant fragrance to the laundered materials. Examples of such botanical materials include citrus fruit rind, dehydrated lavender, rose, gardenia, flower petals, lemongrass stems, peppermint leaves, and chamomile flowers. In addition this smaller sachet may contain essential oils and fragrances which have been loaded onto substrates such as powdered clays, zeolites and organically derived microsponge carrier materials.

### EXEMPLIFICATION

This invention is further illustrated by the following examples which are provided for the purpose of illustration only and the invention should in no way be construed as being limited to these examples but rather should be construed to encompass any and all variations which become evident as a result of the teaching provided herein. The contents of all references, patents, and published patent applications cited throughout this is application, as well as the figures, are incorporated herein by reference.

### Example 1

### Construction and Use of Biodegradable Package

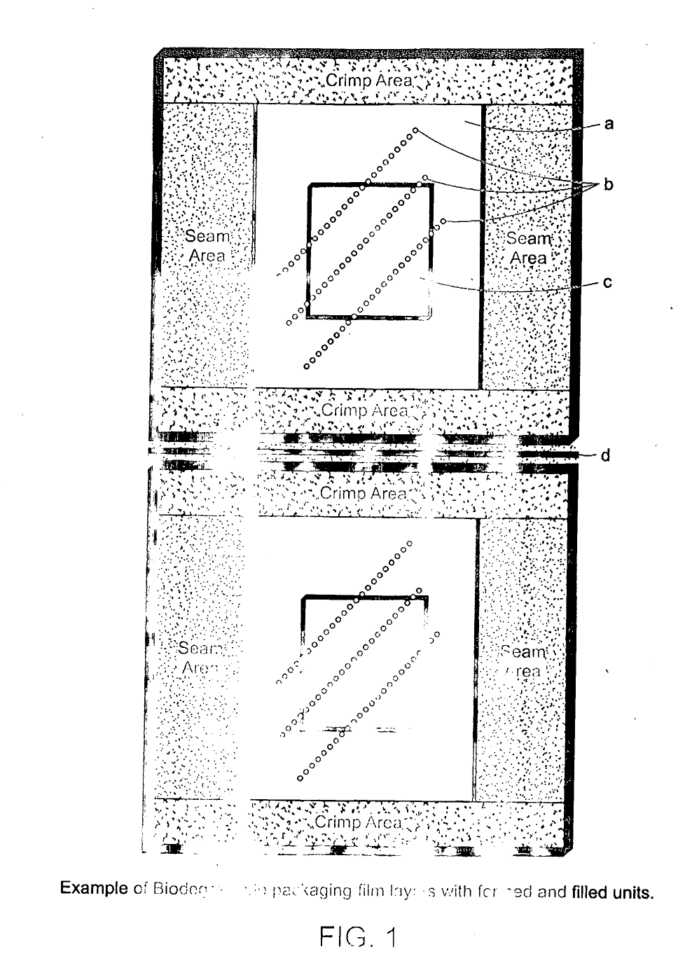

The biodegradable package is constructed of layers of a biodegradable film that is resistant to water and high wash water temperatures (above about 80° F. end below about 160° F.) and remains structurally intact when placed with wet laundry into a drying device that maintains operational air influent temperatures averaging about 347° F. An exemplary package is shown in FIG. 1. This accidental inclusion can occur when the end user of this pericarp package fails to remove it from the laundered materials and inadvertently places it into the clothes drying device.

The biodegradable package is constructed of layers of biodegradable film, wherein the layers are opaque, clear, or where one or more layers is opaque and the other(s) are clear. In one embodiment, multiple Film layers (2, 3, 4 or more) are cut and arranged then fused by heat or adhesive in a fashion to create one thick layer of opaque film with a clear window that allows the visual inspection of the contents of the final package created with the fused film layers.

In another embodiment, the biodegradable package is constructed of layers of biodegradable film that can both opaque and clear. Multiple film layers (2 or more) are cut and arranged, then fused by heat or adhesive in a fashion to create one thick layer of opaque film with printing on the clear layer that becomes more easily visible in contrast to the opaque layer of film underneath. The layers are arranged in such a manner that the printing becomes fused or sandwiched and protected when the layers are joined and as such prevents damage to the printing from the wash water.

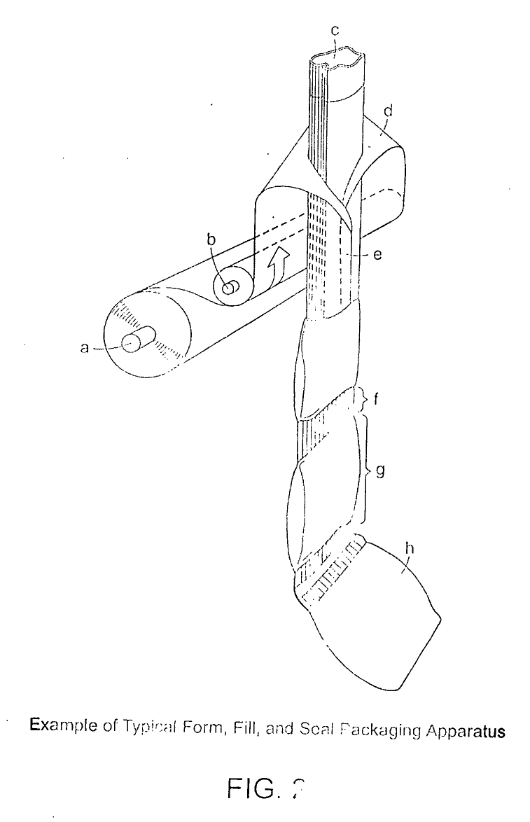

The package is filled with at least about 1-20 grams of botanical materials. An exemplary Form, Fill, and Seal Packaging Apparatus is shown in FIG. 2. In one embodiment, the package comprises about 3-5 grams, 5-10 grams, or 10-15 grams. In one embodiment, 3, 4, or 5 grams is used. In one embodiment, 3-5 sapindus nuts are used. Some variability in the amount is expected. Typically, the package is at least about 1-8 inches×1-8 inches in dimension. In one embodiment, the package is about 3-5 inches×3-5 inches.

The biodegradable package is perforated in specific locations to allow water to infiltrate the bag and diffuse actives from the botanical ingredients contained therein. The perforations may be circular or elongated slits or cuts and arranged in a fashion as to maintain the structural integrity of the package while allowing for the unencumbered flow of wash water through the package. These perforations in the film are made using a device that utilizes needles, or blades to puncture or cut the film material in the specified locations. This device may also use heat or ultrasonic sound to create the desire perforations. In one embodiment, the perforations number between about 1-25 per square inch (e.g., 1, 2, 3, 4, 5, 6, 7, 8, 9, 10, 11, 12, 13, 14, 15, 16, 20, 25). In another 4 and 16 per square inch. Perforations may be on one side of the package or on both sides. In certain embodiments, the bag comprises at least about 5-10, 10-20, 30-50 or more perforations per side. Preferably, the perforations are about 1-25 mm in diameter (e.g., 1, 3, 5, 10, 15, 20, 25).

In one working example, perforations are made in the biodegradable plastic using a machine that pierces the plastic with one or more heated pins. The shape and dimension of the holes varies according to the temperature of the heated probe us well as the lag time between pierces applied to the film. At lower temperatures, the perforations are typically cylindrical in shape, while at higher temperatures (i.e., temperatures sufficient to melt the film) the perforations are more oblong. In particular embodiments, pin temperatures vary between about 90 to 250 F, depending on the size and shape of desired perforation. One of skill in the art will optimize the perforations to enhance release of the Sapindus or Sapindus extract while still maintaining bag integrity. In general, this optimization involves varying the speed of the machine and varying the pin temperature. Sufficient perforations to In other embodiments, other piercing methods are used. Such methods may result in cylindrical perforations, oblong perforations, or slits. Typically, Perforations are made in the body of the package, but do not extend to the seam (e.g., are at least about 0.25, 0.5, 0.75, 1.0″ from the seam).

The biodegradable package constructed of perforated biodegradable film and intended to enclose a variety of botanical ingredients (one or more) which when submerged in aqueous solution disburse active chemical constituents that aid in the laundering of fabrics and linens and may impart a fragrance to the laundered fabric.

### REFERENCES

1. Wetzel, R. G. 1983. Limnology. 2nd ed. Saunders College Publishing, Philadelphia. 767 pp.
2. ReVelle, P. and C. ReVelle. 1988. The Environment: Issues and Choices for Society. 3rd ed. Jones and Bartlett Publishers. Boston. 749 pp.
3. Patterson, Robert A. 1997 Domestic Wastewater and the Sodium Factor. Special Technical Publication 1324 May 1997
4. Model 1500 VFFS Specification Sheet, Universal Packaging, Inc. Houston, Tx.

### Other Embodiments

From the foregoing description, it will be apparent that variations and modifications may be made to the invention described herein to adopt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

What is claimed is:

1. An environment safeguarding detergent package, wherein the package comprises Sapindus or a fragment or derivative thereof encased in a biodegradable plastic.

2. The package of claim 2, wherein the Sapindus is selected from the group consisting of Sapindus delavayi, Sapindus drummondii, Sapindus emarginatus, Sapindus marginatus, Sapindus mukorossi, Sapindus oahuensis, Sapindus rarak, Sapindus saponaria, Sapindus tomentosus, and Sapindus trifoliatus.

3. The package of claim 2, wherein the Sapindus is a blend of Sapindus trifoliatus and Sapindus mukorossi.

4. The package of claim 1, wherein the biodegradable plastic is a polyester.

5. The package of claim 2, wherein the polyester is selected from the group consisting of polylactic acid, polyhydroxybutyrate, polycaprolactone, polyhydroxyalkanoates, polyhydroxyhexanoate, polybutylene succinate, aliphatic-aromatic copolyesters, polybutylene adipate/terephthalate, polyhyroxyvalerate, polybutylene succinate adipate, polyethylene terephthalate and polymethylene adipate/terephthalate.

6. An environment safeguarding detergent package, wherein the package comprises a detergent composition comprising Sapindus or a fragment of derivative thereof, and the detergent composition is encased in a biodegradable bioplastic resin

7. The package of claim 6, wherein the bioplastic resin comprises polylactic acid and corn/wheat starch.

8. The package of claim 1 or 6, wherein the package is perforated.

9. The package of claim 5, wherein the perforations are between about 0.5 and 5.0 mm in size.

10. The package of claim 6, wherein the perforations number between about 4 and 16 per square inch.

11. The package of claim 1, wherein the overall dimensions of the package ranges between about 2″×2.5″ and 5″×8″.

12. The package of any of claims 1-11, wherein the biodegradable plastic is a film.

13. The package of any of claims 1-11, wherein the biodegradable plastic is resistant to water and water temperatures between about 80° F. and 160° F.

14. The package of any of claims 1-11, wherein the package remains intact in a drying device having air influent temperatures of about 347° F.

15. The package of any of claims 1-11, wherein the package and detergent composition are biodegradable and compostable.

16. The package of claim 15, wherein the package and detergent composition biodegrade by about 60% within 180 days in the environment.

17. The package of any of claims 1-16, wherein the package comprises an amount of detergent sufficient for at least about five separate washing periods.

18. The package of any of claims 1-16, wherein the package comprises an indicator of when the package has lost its detergency efficacy.

19. The package of any of claims 1-16, wherein the detergent composition comprises or consists of one or more Sapindus pericarps.

20. The package of any of claims 1-16, wherein the Sapindus pericarp is whole, milled, or ground.

21. The package of any of claims 1-16, wherein the detergent is released into liquid water or steam.

22. The package of any of claims 1-16, said package further comprising at least one additional botanical selected from Aloe, prickly pear cactus, chitin, and Moringa oleifera (drumstick tree seed).

23. The package of any of claims 1-16, wherein said additional botanical enhance detergency.

24. The package of any of claims 1-16, wherein said additional botanical modulates the Zeta potential.

25. A laundry kit comprising the package of any of claims 1-21 and a sachet comprising a fragrant botanicals.

26. The kit of claim 25, wherein the fragrant botanical is derived from a fruit, flower, herb, plant leaf, or plant stem.

27. The kit of claim 25, wherein the kit comprises directions for use of the package and sachet.

28. A method of washing dishes comprising the step of providing the package of any of claims 1-16 in an automatic dishwashing machine.

29. A method of washing laundry comprising the step of providing the package of any of claims 1-16 in an automatic laundry washing machine.

30. The package of any one of claims 1-16, wherein the Sapindus is a Sapindus pericarp.
